(19) United States
(12) Patent Application Publication
(10) Pub. No.: US 2026/0019334 A1
(43) Pub. Date: Jan. 15, 2026

(54) AUTOMATIC NODE CONFIGURATION SYSTEM

(71) Applicant: T-Mobile Innovations LLC, Overland Park, VA (US)

(72) Inventor: Oscar CUMMINGS, Lynnwood, WA (US)

(21) Appl. No.: 18/772,832

(22) Filed: Jul. 15, 2024

(51) Int. Cl. H04L 41/08; H04L 41/0859

(52) U.S. Cl. CPC H04L 41/0883; H04L 41/0863

(57) ABSTRACT

Methods and systems provided herein provide for automatic node configuration. A method includes receiving a request for configuration of an access node through a user interface and accessing a library and locating a method of procedure (MOP) corresponding to the request. The method further includes executing the MOP. The method additionally includes saving a resultant access node configuration after execution of the MOP and accepting and processing feedback regarding the resultant access node configuration.

### TECHNICAL BACKGROUND

As wireless networks evolve and grow, challenges arise in configuring the multitudes of network nodes deployed within a network. On a daily basis, network engineers submit support requests to vendors of network equipment in order to configure and test network nodes, particularly when changes to the network, including the introduction of new wireless devices, occur. Network engineers often lack sufficient information to reconfigure and test network nodes without vendor input. Further, in most wireless networks, multiple vendors supply network nodes, thus further complicating the process of configuring and testing these nodes prior to deployment.

The more network nodes that require configuration or testing, the longer the wait for network engineers to accomplish these tasks. Vendors often consider their input for configuration of the network nodes to be an extra task requiring additional payment from the network service providers. Requests submitted from network engineers to vendors are placed in a queue with the vendors and in many cases, the queue is lengthy and vendor resources are unavailable. Node configurations are generally a daily task for network engineers.

Further, configuration of network nodes for use in the radio access network (RAN) are performed using a method of procedure (MOP), which is a step-by step procedure and differs based on the features and nodes being configured. The MOP may be a documented set of step-by-step instructions that outlines the specific actions and sequence of tasks required to complete a particular process or operation. Sometimes, the MOP is not readily available to the vendors, and network engineers have the additional task of searching for the MOP within network resources of the network service provider to share the MOP with the vendor. Furthermore, because multiple vendors provide the nodes, solutions provided from vendors can be vendor-specific. Thus, different solutions may be required for the different nodes. Accordingly, a vendor-agnostic solution is needed to simplify and expedite node configuration and testing for network engineers. Optimally, the solution will provide an amalgamated system capable of performing a self-configuration of network nodes.

### Overview

Exemplary embodiments provided herein include a method for providing automatic node configuration. The method includes receiving a request for configuration of an access node through a user interface. The method further includes accessing a library and locating a method of procedure (MOP) corresponding to the request in the library. The method additionally includes executing the MOP for the access node. The method further includes saving a resultant access node configuration after execution of the MOP and accepting and processing feedback regarding the resultant access node configuration.

Further aspects include a system for automatic node configuration. The system includes an interactive user interface receiving a request for configuration of an access node and a memory storing data and instructions. The system additionally includes a processor executing the stored instructions to perform multiple operations. The operations include accessing a library and locating a method of procedure (MOP) corresponding to the request and executing the MOP for the access node. The operations additionally include saving a resultant access node configuration after execution of the MOP and accepting and processing feedback regarding the resultant access node configuration.

In yet a further aspect, a non-transitory computer-readable medium storing instructions executed by a processor is provided. The processor performs multiple operations. The operations include, upon receipt of a request to configure an access node, accessing a library and locating a method of procedure (MOP) corresponding to the request. The operations further include executing the MOP for the access node and saving a resultant access node configuration after execution of the MOP. Further, the operations include accepting and processing feedback regarding the resultant access node configuration.

### BRIEF DESCRIPTION OF THE DRAWINGS

FIG. 1 depicts an exemplary environment for providing an automatic node configuration system in accordance with an embodiment.

FIG. 2 depicts an exemplary automatic node configuration system in accordance with an embodiment.

FIG. 3 depicts an exemplary access node in accordance with an embodiment.

FIG. 4 depicts a further exemplary environment for automatic node configuration in accordance with an embodiment.

FIG. 5 depicts an exemplary method for automatic node configuration in accordance with an embodiment.

FIG. 6 depicts a further exemplary method for automatic node configuration in accordance with an embodiment.

FIG. 7 depicts an exemplary method for feedback processing during automatic node configuration in accordance with an embodiment.

FIG. 8 depicts a further exemplary method for feedback processing during automatic node configuration in accordance with an embodiment.

FIG. 9 depicts a further exemplary method for feedback processing during automatic node configuration in accordance with an embodiment.

### DETAILED DESCRIPTION

Embodiments provided herein include a method for providing automatic node configuration. Currently, node configuration is a manual process requiring input from multiple system including vendor systems. Embodiments disclosed herein include an automated system. The automated system processes input from a network engineer including a description of a radio access network (RAN) feature or a capability or configuration for building into a specific node, such as an evolved NodeB (eNB) or next generation NodeB (gNB). Accordingly, the automated system provides a user interface accepting input from the network engineer or other user. The interface may be or include, for example, an online chat interface, or a microphone enabled interface. Based on the user input, the automated system may return one or more features and/or MOPS based on stored data related to the access nodes, and the vendors, such as Ericsson® and Nokia®, who provide the access nodes.

Through additional interaction between the user and the automated system, the system confirms the feature the users would like to configure. Once the feature is confirmed, the system will check for an updated MOP and connect to the desired operational support system (OSS) where access nodes are connected and commissioned. The OSS encompasses the information processing systems used by operators to manage their communications networks. The OSS assists network operators and network engineers in designing, building, operating, and maintaining communications networks. The OSS further provides network-facing functionality including, for example: fault and performance management; customer activations; configuration management; and network security.

After saving the current configuration in case of a roll-back, the automated system runs a subset of parameters and commands that satisfy the requested access node configuration. The automated system saves the configuration with identifying information including, for example, a new name and date, and asks the user for feedback. The system user or network engineer may then test the configuration once completed by the automated system.

The user may enter multiple feedback options. For example, when the tests reveal that the configuration performed by the automated system operates as expected, the network engineer may submit feedback indicating that the configuration is good or fully satisfactory. In response to this feedback, the automated system may close the request and send a confirmation email. When testing reveals that the configuration is operational, but in some instances does not operate as expected or has glitches, a feedback option indicating that troubleshooting is required by be submitted. In this instance, the automated system may re-assign the initial request to vendor support of the access node vendor for deeper analysis and resolution. An additional “roll-back” feedback option may be provided when the configuration does not operate as expected. In this instance, the automated system will restore the previously saved configuration to restore the access node to an initial state.

Embodiments disclosed herein utilize artificial intelligence (AI) and a machine learning algorithm for performing various tasks. For example, AI may operate within the user interface to connect to system databases and search the documentation based on submitted requests. Thus, the system utilizes AI for matching human chat wording with wording in the databases and is able to access the OSS system with an anti-failure architecture. Once the system configures a node based on a network engineer request, the configuration requires approvals before proceeding due to criticality involving impacts to other nodes, and further to the goal of having the system utilize its machine learning capability based on feedback in order to become a completely autonomous system over the time. Accordingly, the system becomes faster and more autonomous over time.

An exemplary environment described herein includes multiple access nodes (or base stations), such as eNBs or gNBs, which communicate with a plurality of end-user wireless devices. For illustrative purposes and simplicity, the disclosed technology will be illustrated and discussed as being implemented as configuring the access nodes using an automatic node configuration system.

In addition to the systems and methods described herein, automatic node configuration may be implemented as computer-readable instructions or methods and processing nodes on the network for executing the instructions or methods. The processing node may include a processor included in any controller node or other node in the wireless network that is coupled to the OSS system for configuration of access node.

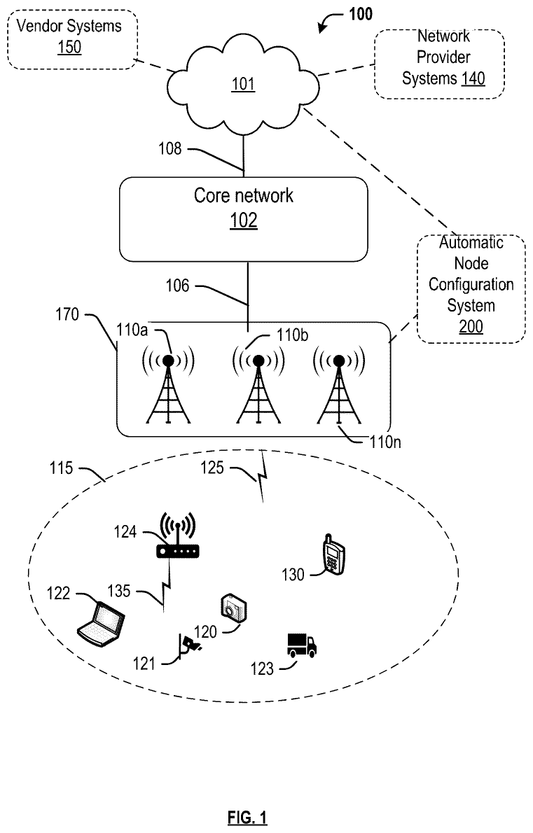

FIG. 1 depicts an exemplary environment 100 for implementing an automatic node configuration system 200 in conjunction with a wireless network. In the displayed environment 100, automatic node configuration system 200 operates to automatically configure access nodes 110a, 110b . . . 110n. The access nodes 110a . . . 110n are configured for communication over wireless links 125, 135 with wireless devices 120, 121, 122, 123, 124, and 130 within a coverage area 115. These wireless devices may be, for example, eMBB devices, IoT devices, wireless hotspot devices or access points, or any other type of wireless device capable of connecting with a wireless network.

Environment 100 comprises a communication network 101, core network 102, and a radio access network (RAN) 170 including multiple access nodes 110a . . . 110n. Further, an automatic node configuration system 200 operates to configure access nodes 110a . . . 110n in the RAN 170. In embodiments disclosed herein, the RAN 170 may, for example, include several hundred access nodes, which may be provided by two or more vendors.

The exemplary operating environment 100 may further include network service provider systems 140, which are accessible over the communication network 101 and are connected to the communication network 101 in any known manner. The service provider systems 140 may include, for example, an OSS system and various libraries, such as for example, a feature library and/or a MOP library. The environment 100 may further include connected vendor systems 150, which are provided by equipment vendors such as the access node vendors. All of these systems may include websites, which may be accessible over the communication network 101, which may be or include the Internet. Additionally, components not shown may include, for example, gateway node(s) controller nodes, and additional access nodes.

The access nodes 110a . . . 110n may be base stations including evolved NodeBs (eNBs) or next generation NodeBs (gNBs) for providing wireless voice and data service to wireless devices in various coverage areas of the one or more access nodes. As wireless technology continues to improve, various different iterations of radio access technologies (RATs) may be deployed within a single wireless network. Such heterogeneous wireless networks can include newer 5G and millimeter wave (mm-wave) networks, as well as 6G or 4G long-term evolution (LTE) access nodes. Access nodes 110a . . . 110n can be any network node configured to provide communication between end-user wireless devices 120, 121, 122 123, 124 and 130 and communication network 101, including standard access nodes and/or short range, low power, small access nodes. For instance, access nodes 110a . . . 110n may include any standard access node, such as a macrocell access node, base transceiver station, a radio base station, an eNB device, an enhanced eNB device, a gNB in 5G networks, or the like.

Further the access nodes 110a . . . 110n may include multiple co-located access nodes, such as a combination of eNBs and gNBs. Access nodes 110a . . . 110n can be a small access node including a microcell access node, a picocell access node, a femtocell access node, or the like such as a home NodeB or a home eNB device. Moreover, it is noted that while access nodes 110a . . . 110n and wireless devices 120, 121, 122, 123, 124, and 130 are illustrated in FIG. 1, any number of access nodes and wireless devices can be implemented within environment 100.

The exemplary operating environment 100 may further include automatic node configuration system 200, which is illustrated as operating between the communication network 101 and the RAN 170. Thus, the automatic node configuration system 200 may be distributed. For example, the automatic node configuration system 200 may utilize components located at any one or more of the above-described locations. Alternatively, the automatic node configuration system 200 may be an entirely discrete system operating in conjunction with the communication network 101, the RAN 170, core 102 and/or the wireless devices 120, 121, 123, 130, 131, 133.

The automatic node configuration system 200 receives input from users such as network engineers pertaining to the nodes 110a . . . 110n and features of the nodes for configuration. Features may include, for example, modulation schemes, multiple in multiple out (MIMO) schemes, duplexing modes, etc. As set forth above, the input may be presented to the automatic node configuration system through an online chat system and may include typewritten or audio input. The automatic node configuration system 200 processes the input using AI to understand the features for configuration and retrieve the MOP corresponding to the features for configuration. Further, the automatic node configuration system 200 connects to the OSS and applies the MOP in order to automatically configure the selected feature for the selected node 110a . . . 110n. For example, the automatic node configuration system 200 may configure a modulation scheme, a MIMO scheme, or a duplexing mode for the selected node 110a . . . 110n. After configuration, the network engineer or other user may test the configured node and provide feedback to the automatic node configuration system 200. Through a machine learning algorithm, the automatic node configuration system 200 processes the feedback to improve node configuration over time. Further, although the automatic node configuration system 200 is shown as a separate node communicating with the network 101 and the RAN 170, the automatic node configuration system 200 could be incorporated in the RAN 170 or the core 102 or disposed in a different location.

Wireless devices 120, 121, 122, 123, 124, and 130 may be any device, system, combination of devices, or other such communication platform capable of communicating wirelessly with access node 110 using one or more frequency bands deployed therefrom. For example, the wireless devices 120, 121, 123 may include IoT devices that build a network of physical objects or things that are embedded with sensors, software, and other technologies for the purpose of connecting and exchanging data with other devices and systems over the Internet or communication network 101. Wireless devices 130 and may be, for example, an eMBB device. The wireless devices 130 may be or include, for example, a mobile phone, a wireless phone, a wireless modem, a personal digital assistant (PDA), a voice over internet protocol (VOIP) phone, a voice over packet (VOP) phone, a soft phone. Wireless device 124 may be or include a wireless access point, a home internet (HINT) device, a fixed wireless access (FWA) device as well as other types of devices or systems that can exchange audio or data via access node 110.

The core network 102 includes core network functions and elements. The core network may be structured using a service-based architecture (SBA). The network functions and elements may be separated into user plane functions and control plane functions. In an SBA architecture, service-based interfaces may be utilized between control-plane functions, while user-plane functions connect over point-to-point link. The user plane function (UPF) accesses a data network, such as network 101, and performs operations such as packet routing and forwarding, packet inspection, policy enforcement for the user plane, quality of service (QOS) handling, etc. The control plane functions may include, for example, a network slice selection function (NSSF), a network exposure function (NEF), a network repository function (NRF), a policy control function (PCF), a unified data management (UDM) function, an application function (AF), an access and mobility function (AMF), an authentication server function (AUSF), and a session management function (SMF). Additional or fewer control plane functions may also be included. The AMF receives connection and session related information from the wireless devices 120, 121, 123, 130, and 132 and is responsible for handling connection and mobility management tasks. The SMF is primarily responsible for creating, updating, and removing sessions and managing session context. The UDM function provides services to other core functions, such as the AMF, SMF, and NEF. The UDM function may function as a stateful message store, holding information in local memory. The NSSF can be used by the AMF to assist with the selection of network slice instances that will serve a particular device. Further, the NEF provides a mechanism for securely exposing services and features of the core network 102.

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless devices 120, 121, 122, 123, 124, and 130. Wireless network protocols can comprise multimedia broadcast multicast service (MBMS), code division multiple access (CDMA) 1×RTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), and Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE). Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 can also comprise additional base stations, controller nodes, telephony switches, internet routers, network gateways, computer systems, communication links, or some other type of communication equipment, and combinations thereof.

Communication links 106 and 108 can use various communication media, such as air, space, metal, optical fiber, or some other signal propagation path, including combinations thereof. Communication links 106 and 108 can be wired or wireless and use various communication protocols such as Internet, Internet protocol (IP), local-area network (LAN), optical networking, hybrid fiber coax (HFC), telephony, T1, or some other communication format. Communication links 106 and 108 can be a direct link or might include various equipment, intermediate components, systems, and networks. Communication links 106 and 108 may comprise many different signals sharing the same link.

Other network elements may be present in environment 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between access nodes 110a . . . 110n and communication network 101.

Further, the methods, systems, devices, networks, access nodes, and equipment described above may be implemented with, contain, or be executed by one or more computer systems and/or processing nodes. The methods described above may also be stored on a non-transitory computer readable medium. Many of the elements of communication environment 100 may be, comprise, or include computers systems and/or processing nodes.

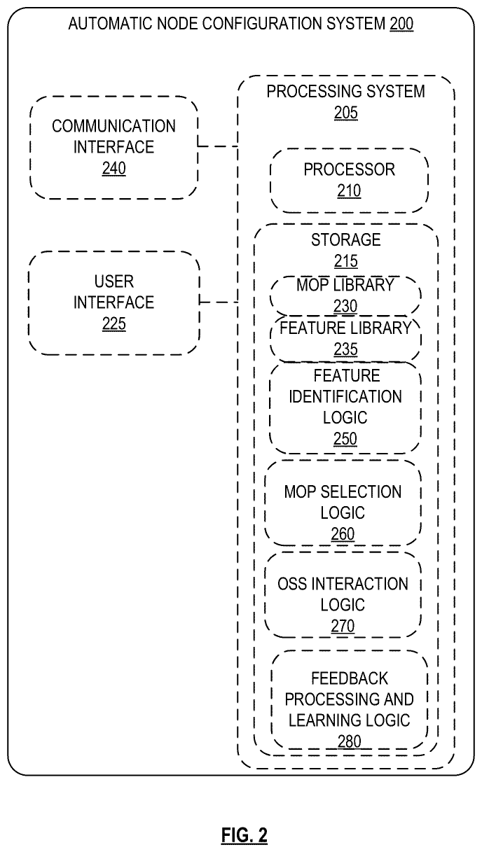

FIG. 2 illustrates an automatic node configuration system 200 in accordance with embodiments described herein. The components described herein are merely exemplary as many different configurations for the automatic node configuration system 200 may be implemented. The automatic node configuration system 200 may be configured to perform the methods and operations disclosed herein to automatically configure access nodes 110a . . . 110n based on network engineer requests submitted. In the disclosed embodiments, the automatic node configuration system 200 may be a separate processing node communicating with the RAN 170 or may be incorporated in the core network 102 or the RAN 170. Other configurations are within scope of the disclosure. Further, the components of the automatic node configuration system 200 may be distributed so that one or more components is located at an access node 110a . . . n or elsewhere in the RAN 170 and one or more other components are located within a separate processing node.

To perform processes for automated node configuration, the automatic node configuration system 200 may utilize a processing system 205. Processing system 205 may include a processor 210 and a storage device 215. Storage device 215 may include a RAM, ROM, disk drive, a flash drive, a memory, or other storage device configured to store data and/or computer readable instructions or codes (e.g., software). The computer executable instructions or codes may be accessed and executed by processor 210 to perform various methods disclosed herein.

The automatic node configuration system 200 may be configured for collecting data stored in network databases. The network databases may, for example, include a MOP library 230 and/or a feature library 235. While the MOP library 230 and the feature library 235 are shown as being incorporated in the storage area 215 of the automatic node configuration system 200, the MOP library 230 and the feature library 235 may be separately stored as a network service provider system 140 and accessed over the communication network 101 by the automatic node configuration system 200.

Software stored in storage device 215 may include computer programs, firmware, or other form of machine-readable instructions, including an operating system, utilities, drivers, network interfaces, applications, or other type of software. For example, software stored in storage device 215 may include a module for performing various operations described herein. For example, in some embodiments, feature identification logic 250 may store instructions for processing user requests, such as requests from network engineers to identify features for configuration. For example, the feature identification logic 250 may operate in an on-line chat environment to identify the one or more features and an access node requiring configuration based on user input. The feature identification logic 250 may include AI and/or a machine learning algorithm that improves the identification of features over time. The feature identification logic 250 may provide an input interface to the network engineers or other users requesting configuration of features associated with the access nodes 110a . . . 110n. In some embodiments, the feature identification logic 250 may interact with the network service provider systems 140 to provide a website accessible to network engineers for submission of requests.

The software may additionally include MOP selection logic 260. The MOP selection logic 260 is triggered upon completion of feature identification to select a corresponding MOP to utilized during configuration of one or more of the access nodes 110a . . . 110n. The MOP selection logic 260 may also include a machine learning algorithm to allow it to improve over time. Responsive to the selection of a MOP, OSS interaction logic 270 may be triggered in order to interact with the OSS and execute the submitted request by configuring the feature for the identified access node. Finally, the automatic node configuration system 200 may include feedback processing and learning logic 280, which accepts feedback on the configuration from network users such as network engineers. Based on the submitted feedback, the feedback processing and learning logic 280 may utilize a machine learning algorithm to improve its performance over time and create an entirely autonomous automatic node configuration system 200.

Processor 210 may be a microprocessor and may include hardware circuitry and/or embedded codes configured to retrieve and execute software stored in storage device 215. The automatic node configuration system 200 further includes a communication interface 240 and a user interface 225. Communication interface 240 may be configured to enable the processing system 205 to communicate with other components, nodes, or devices in the wireless network or with vendor systems 150 and network service provider systems 140 accessible over the network 101. For example, during execution of the feedback processing loop, the feedback processing and learning logic 280 may utilize the communication interface 240 to access the vendor systems 150 over the communication network 101.

Communication interface 240 may include hardware components, such as network communication ports, devices, routers, wires, antenna, transceivers, etc. User interface 225 may be configured to allow a user, such as a network engineer, to identify a feature and a particular access node 110a . . . 110n for configuration. User interface 225 may include hardware components, such as touch screens, buttons, displays, speakers, etc. The automatic node configuration system 200 may further include other components such as a power management unit, a control interface unit, etc.

The location of the automatic node configuration system 200 may depend upon the network architecture. As set forth above, the automatic node configuration system 200 may be located in a separate processing node, in the RAN 170, in multiple locations, or may be an entirely discrete component. Further, although shown as a single integrated system, the functions of feature identification, MOP selection, OSS interaction, and feedback processing may be separated and disposed in separate locations.

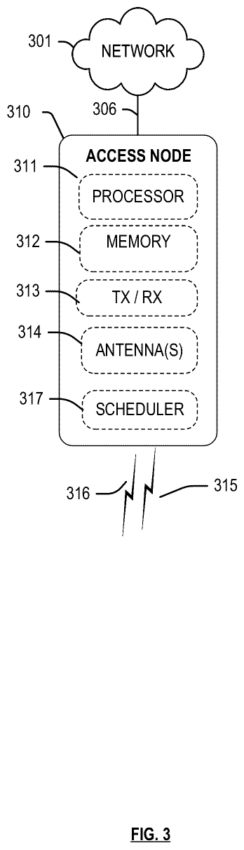

FIG. 3 depicts an exemplary access node 310. Access node 310 may have a structure similar to that of access nodes 110a . . . 110n and is configured as an access point for providing network services from a network 301 to end-user wireless devices such as wireless devices shown and described with respect to FIG. 1. Access node 310 is illustrated as comprising a memory 312 for storing logical modules that perform various operations, a processor 311 for executing the logical modules, and a transceiver 313 for transmitting and receiving signals via antennas 314. Combinations of antennas 314 and transceivers 313 are configured to deploy one or more wireless air interfaces. The deployment may utilize one or more carriers, each of which uses a different frequency band. Further, the different sets of antennas can be used to implement various transmission modes or operating modes in each sector, including but not limited to MIMO (including SU-MIMO, MU-MIMO, mMIMO, beamforming, etc.), CA, and different duplexing modes including frequency division duplexing (FDD) and time division duplexing (TDD).

Further, access node 310 is communicatively coupled to network 301 via communication interface 306, which may be any wired or wireless link as described above. Scheduler 317 may be provided for scheduling resources based on the presence and performance parameters of the wireless devices. Wireless communication links 315 and 316 may deploy different duplexing modes including TDD and FDD.

Various features of the access node 310 may be configured. For example, the antennas 314 may be configured for various MIMO modes described above and also various modulation schemes. Additionally, the scheduler 317 may be configured for scheduling of resources. Further, the memory 312 may store logic for interaction with the automatic node configuration system 200.

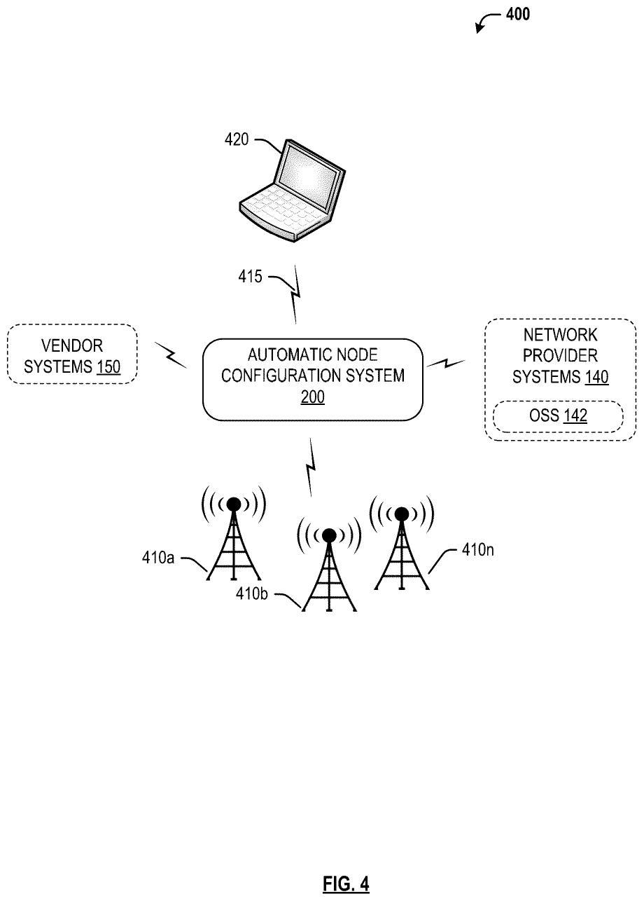

FIG. 4 illustrates a localized environment 400 for operation of the automatic node configuration system 200. A user, such as a network engineer, may utilize a computing device 420 to access the automatic node configuration system 200. The computing device 420 may be or a include a wired or a wireless device. The computing device 420 may access the automatic node configuration system 200 using cellular communications via RAN 170 and communication network 101. Alternatively, the computing device 420 may access the automatic node configuration system 200 using an internet service provider (ISP) through the communication network 101. The automatic node configuration system 200, through the features described above, causes a user interface to be displayed on the computing device 420 enabling the network engineer to submit at least an identification of an access node 410a, 410b, 410n for configuration as well as the feature of the access node 410a, 410b, 410n requiring configuration. In order to perform the configuration, the automatic node configuration system 200 communication with network service provider systems 140, which may include, for example, the MOP library 230 and the OSS 142. For the execution of the feedback processing and learning logic 280, the automatic node configuration system 200 may communicate with the vendor systems 150.

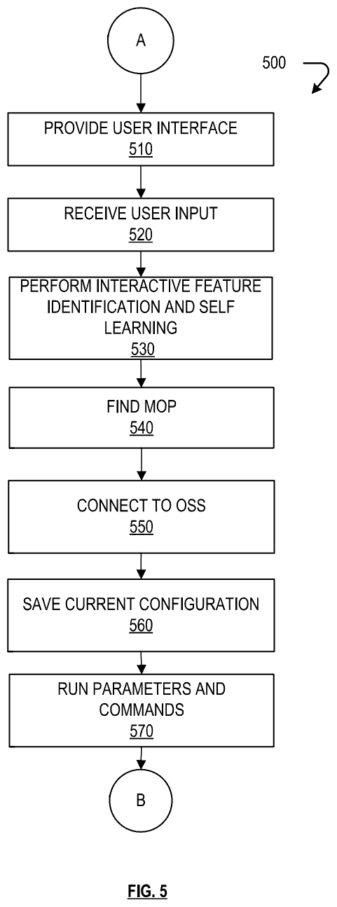

FIG. 5 illustrates an exemplary method 500 for automatic node configuration. Method 500 may be performed by any suitable processor discussed herein, for example, a processor 210 included in the automatic node configuration system 200. For discussion purposes, as an example, method 500 is described as being performed by the processor 210 included in the automatic node configuration system 200.

Method 500 starts in step 510, in which the processor 210 provides a user interface. The user interface may provide, for example, an online chat user interface. As an alternative, as the user interface evolves over time through the machine learning algorithm, the user interface may provide a selection of access nodes as well as a selection of features for identification by the user. In step 520, the processor 210 receives the user input, which may include input data pertaining to an access node and one or more features for configuration. For example, the user may request a configuration on an Ericsson® node that does 4×4 MIMO and 256 quadrature amplitude modulation (QAM). Using 256-QAM, a carrier wave of constant frequency can exist in one of 256 different discrete and measurable states in the constellation plot. Thus, the user describes the characteristics of the node and the desired feature or features.

The method continues in step 530, in which the processor 210 performs interactive feature identification and self-learning. More specifically, based on the user input, the automatic node configuration system 200 attempts to identify the feature for configuration requested by the user, for example, in the feature library 235. Thus, the request includes a description of a feature and the operations further include analyzing the request to identify the feature. The features library 235 may include a standardized library of terms as different vendors may use different terminology. The processor 210 may provide the identified feature to the user through the user interface and request confirmation. Upon receiving user confirmation, the processor 210 confirms the feature and utilizes its machine learning algorithm to improve its feature identification skills. Accordingly, the processor 210 implements a machine learning algorithm to improve feature identification

In step 540, the processor 210 locates the MOP corresponding to the feature. For example, the processor 210 searches the MOP library 230 to locate the MOP corresponding to the selected feature. The MOP might not have the same exact name as the identified feature, but may be similar. For example, physical resource block (PRB) blanking for Ericsson® nodes may be saved as spectrum sharing. Thus, the processor, using AI may extract the identified MOP and send a message to the user asking if the identified MOP is the correct MOP. If the user states that the MOP is incorrect, the processor 210 presents other candidates for the MOP until the correct MOP is found. Once the correct MOP is found, In some embodiments, the processor 210 may ask the user when the MOP should be executed. Based on user input, the processor 210 may execute the MOP at a particular time, for example, overnight, so that the user will be able to test the new configuration in the morning.

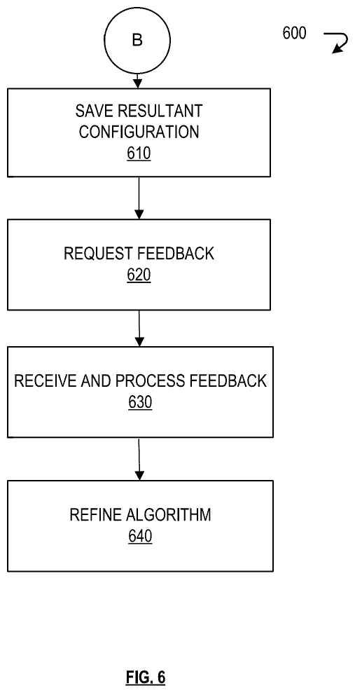

During or upon selection of the MOP and scheduling of execution, the processor 210 triggers connection to the OSS 142 in step 550. By logging into the OSS, the processor 210 may obtain node information and make sure that the node is active and check its configuration. Prior to reconfiguration, the processor 210 saves the current node configuration in step 560 to create a saved access node configuration. After saving the current node configuration, the processor 210 runs the parameters and commands in the OSS as directed in the selected MOP in step 570. Upon completion of running the parameters and commands in step 570, the processor has configured the requested feature on the specified node and the method proceeds from part A to part B and FIG. 6.

FIG. 6 depicts an exemplary method 600 for automatic node configuration in accordance with embodiments described herein. More specifically, method 600 pertains to part B of method 500. In step 610, the processor 210 saves the configuration resulting from the running of parameters and commands in step 570. After saving the configuration in step 610, the processor 210 requests feedback in step 620. The user may enter feedback through the user interface and in step 630, the processor 210 may receive and process the feedback. Based on the processing of the feedback in step 630, the processor 210 may refine its stored logic based on the feedback in step 640. Thus, the processor 210 performs self-learning based on the processed feedback.

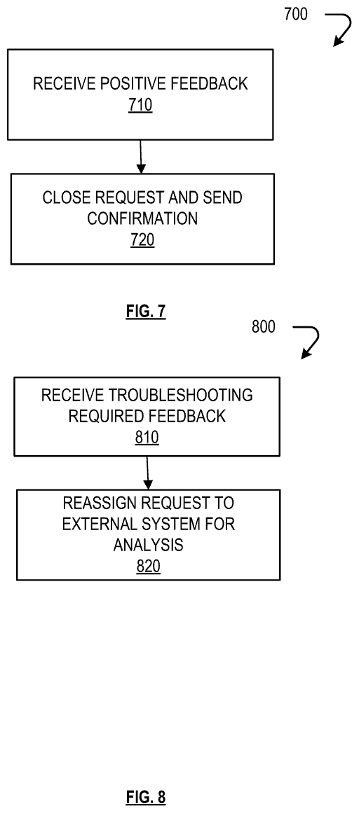

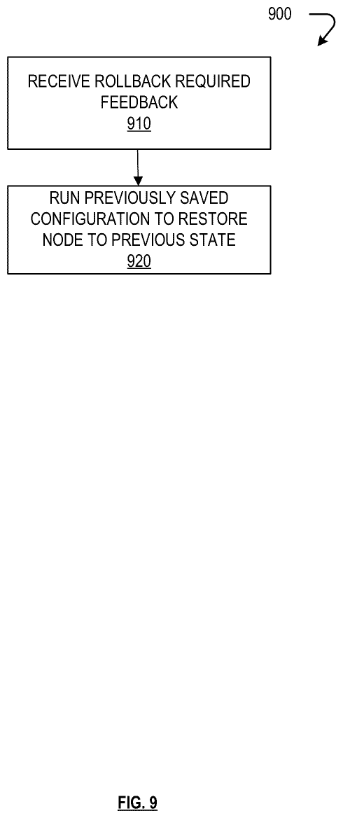

FIG. 7-9 illustrate various feedback methods in accordance with embodiments disclosed herein. Methods 700, 800, and 900 may be performed by any suitable processor discussed herein, for example, a processor 210 included in the automatic node configuration system 200. For discussion purposes, as an example, methods 700, 800, and 900 are described as being performed by the processor 210 included in the automatic node configuration system 200.

In method 700, the processor 210 receives positive feedback from the user in step 710 regarding a saved configuration, such as the saved resultant configuration in step 610 of FIG. 6. For example, the user tests the saved configuration and finds that the configured node operates as expected. Accordingly, the user submits the positive feedback, which is received at step 710. In step 720, the processor 210 closes the request and sends a confirmation message to the requesting user. Accordingly, method 700 illustrates accepting and processing positive feedback

In method 800, the processor 210 receives feedback in step 810 indicating that troubleshooting is required. For example, the user tests the saved configuration and identifies glitches or situations in which a saved configuration, such as the saved resultant configuration in step 610 of FIG. 6, does not operate as expected. In this instance, the user submits a troubleshooting feedback request, which is received in step 810. In response to the troubleshooting request received in step 810, the processor 210 may reassign the request to an external system, such as the vendor system 150 for further analysis in step 820. Accordingly, if the access node 110 was provided by Nokia®, the troubleshooting may be assigned to a Nokia® system. If the access node 110 was provided by Ericsson®, the troubleshooting may be assigned to an Ericsson® external system.

In method 900, the processor 210 receives feedback that a rollback is required in step 910. For example, the user may test a saved configuration, such as the saved resultant configuration in step 610 of FIG. 6, and determine that it does not operate at all as expected. Accordingly, the user may submits the feedback via a user interface in step 910 that a rollback is required. In response to the feedback, in step 920, the processor 210 runs the previously stored configuration, saved in step 560 of FIG. 5 in order to restore the node to its previous state. Thus, the processor 210 causes the reverting of the access node to its stored state. In this instance, the process may be repeated or may be assigned to an external vendor system 150. Thus, as illustrated in FIGS. 7-9, the processor 210 performs self-learning based on the processed feedback.

In some embodiments, methods 500, 600, 700, 800, and 900 may include additional steps or operations. Furthermore, the methods may include steps shown in each of the other methods. Additionally, the order of steps shown is merely exemplary and the steps may be re-ordered as appropriate. As one of ordinary skill in the art would understand, the methods 500, 600, 700, 800, and 900 may be integrated in any useful manner.

The steps of the methods described above can be combined or rearranged in any meaningful manner. Further, the exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

1. A method comprising:
receiving a request for configuration of an access node through a user interface;
accessing a library and locating a method of procedure (MOP) corresponding to the request;
executing the MOP for the access node;
saving a resultant access node configuration for the access node after execution of the MOP; and
accepting and processing feedback regarding the resultant access node configuration.

2. The method of claim 1, further comprising performing self-learning based on the processed feedback.

3. The method of claim 1, wherein the receiving includes receiving the request through a chat user interface.

4. The method of claim 1, wherein the request comprises description of a feature and the method further comprise analyzing the request to identify the feature.

5. The method of claim 4, further comprising implementing a machine learning algorithm to improve feature identification.

6. The method of claim 1, wherein the accepting and processing the feedback includes receiving feedback that a rollback of the access node configuration is required and reverting to a saved access node configuration for the access node upon receiving the feedback that a rollback is required.

7. The method of claim 1, wherein the accepting and processing the feedback includes receiving feedback that troubleshooting is required for the resultant access node configuration and assigning the request to an external system.

8. The method of claim 1, wherein the accepting and processing feedback includes accepting and processing positive feedback.

9. The method of claim 8, further comprising closing the request and sending a confirmation in response to the positive feedback.

10. The method of claim 1, wherein executing the MOP for the access node includes accessing an operational support system (OSS) to execute the MOP on the access node.

11. A system comprising:
an interactive user interface receiving a request for configuration of an access node;
a memory storing data and instructions; and
a processor executing the stored instructions to perform operations including:
accessing a library and locating a method of procedure (MOP) corresponding to the request;
executing the MOP for the access node;
saving a resultant access node configuration for the access node after execution of the MOP; and
accepting and processing feedback regarding the resultant access node configuration.

12. The system of claim 11, wherein the operations further comprise performing self-learning based on the processed feedback.

13. The system of claim 11, wherein the request is received through a chat user interface.

14. The system of claim 11, wherein the operations further comprise accessing an operational support system (OSS) to execute the MOP on the access node.

15. The system of claim 11, wherein the operations further comprise receiving feedback that a rollback of the resultant access node configuration is required and reverting to the saved access node configuration.

16. The system of claim 11, wherein the feedback indicates that troubleshooting is required and the operations further comprise assigning the request to an external system.

17. The system of claim 11, wherein the accepting and processing feedback comprises processing positive feedback by closing the request and sending a confirmation.

18. A non-transitory computer-readable medium storing instructions executed by a processor to perform operations including:
upon receipt of a request to configure an access node, accessing a library and locating a method of procedure (MOP) corresponding to the request;
executing the MOP for the access node;
saving a resultant access node configuration for the access node after execution of the MOP; and
accepting and processing feedback regarding the resultant access node configuration.

19. The non-transitory computer-readable medium of claim 18, the operations further comprising performing self-learning based on the processed feedback.

20. The non-transitory computer-readable medium of claim 18, wherein the request comprises description of a feature and the operations further comprise analyzing the request to identify the feature.
